(19) United States
(12) Patent Application Publication
(10) Pub. No.: US 2021/0209962 A1
(43) Pub. Date: Jul. 8, 2021

(54) TEACHING SYSTEM AND METHOD, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventors: Wenhui CAI, Shanghai (CN); Lu LU, Shanghai (CN); Yuzhu ZOU, Shanghai (CN); Juan DAI, Shanghai (CN); Jintong JU, Shanghai (CN)

(21) Appl. No.: 17/209,616

(22) Filed: Mar. 23, 2021

Related U.S. Application Data
(63) Continuation of application No. PCT/CN2019/124414, filed on Dec. 10, 2019.

(30) Foreign Application Priority Data
Sep. 25, 2019 (CN) 201910677489.9

(51) Int. Cl. G09B 19/00; G06F 8/41; G06F 9/50

(52) U.S. Cl. CPC G09B 19/0053; G06F 9/5027; G06F 8/433

(57) ABSTRACT

A teaching method includes: receiving an experimental operation instruction sent by a front-end application device, wherein the experimental operation instruction is an operation instruction for performing a step of a target experiment in a curriculum package, the curriculum package comprises one or more programming experiments, and the target experiment is any one of the one or more programming experiments; executing the experimental operation instruction based on a running dependency package corresponding to the target experiment, to obtain an execution result; and sending the execution result to the front-end application device.

### CROSS-REFERENCE TO RELATED APPLICATIONS

The present application is a continuation of International Application No. PCT/CN2019/124414, filed on Dec. 10, 2019, which claims priority of Chinese Patent Application No. 201910677489.9, filed on Jul. 25, 2019. The disclosures of International Application No. PCT/CN2019/124414 and Chinese Patent Application No. 201910677489.9 are hereby incorporated by reference in their entireties.

### BACKGROUND

Computer education is important in primary and secondary schools. However, with a lack of basic mathematical knowledge and poor understanding of complex logic, it is difficult for primary and secondary school students to learn complex code. In some programming learning environments, programming operations can be complex and require deep mathematical logic knowledge to understand and master them.

### SUMMARY

Embodiments of the present disclosure relate to, but are not limited to, the technical field of computers, in particular to a teaching system and method, an electronic device, and a storage medium.

According to a first aspect of the embodiments of the present disclosure, a teaching method is provided, and the method is applied to a background service device, including: receiving an experimental operation instruction sent by a front-end application device, wherein the experimental operation instruction is an operation instruction for performing a step of a target experiment in a curriculum package, the curriculum package includes one or more programming experiments, and the target experiment is any one of the one or more programming experiments; executing the experimental operation instruction based on a running dependency package corresponding to the target experiment, to obtain an execution result; and sending the execution result to the front-end application device.

According to a second aspect of the embodiments of the present disclosure, a teaching method is provided, and the method is applied to a front-end application device, including: receiving an experimental operation instruction, and sending the experimental operation instruction to a background service device, wherein the experimental operation instruction is an operation instruction for performing a step of a target experiment in a curriculum package, the curriculum package includes one or more programming experiments, and the target experiment is any one of the one or more programming experiments; and receiving and displaying an execution result corresponding to the experimental operation instruction.

According to a third aspect of the embodiments of the present disclosure, a teaching system is provided that includes a background service device configured to: receive an experimental operation instruction sent by a front-end application device, wherein the experimental operation instruction is an operation instruction for performing a step of a target experiment in a curriculum package, the curriculum package comprises one or more programming experiments, and the target experiment is any one of the one or more programming experiments; execute the experimental operation instruction based on a running dependency package corresponding to the target experiment, to obtain an execution result; and send the execution result to the front-end application device.

It is to be understood that both the foregoing general descriptions and the following detailed descriptions are exemplary and explanatory, and are not restrictive of the disclosure, as claimed.

Further features and aspects of the present disclosure will become apparent from the following detailed description of exemplary embodiments with reference to the accompanying drawings.

### BRIEF DESCRIPTION OF THE DRAWINGS

The accompanying drawings herein are incorporated in the specification, become a part of the specification, show embodiments that are in accordance with the present disclosure, and are used with the specification to explain technical solutions of the present disclosure.

FIG. 1 is a block diagram of a teaching system according to an embodiment of the present disclosure;

FIG. 2 is a schematic diagram of an application of a teaching system according to an embodiment of the present disclosure;

FIG. 3 is a flowchart of a teaching method according to an embodiment of the present disclosure;

FIG. 4 is a flowchart of a teaching method according to an embodiment of the present disclosure;

FIG. 5 is a block diagram of an electronic device according to an embodiment of the present disclosure;

FIG. 6 is a block diagram of an electronic device according to an embodiment of the present disclosure.

### DETAILED DESCRIPTION OF EMBODIMENTS

Various exemplary embodiments, features, and aspects will be described in detail below with reference to the accompanying drawings. Like accompanying symbols in the accompanying drawings represent elements with like or similar functions. Although various aspects of the embodiments are illustrated in the accompanying drawing, the accompanying drawings are not necessarily drawn in proportion unless otherwise specified.

The special term “exemplary” herein refers to “can be used as an example, an embodiment, or an illustration”. Any embodiment described as “exemplary” herein is not necessarily to be interpreted as being superior to or better than other embodiments.

The term “and/or” in this specification describes only an association relationship between associated objects and represents that three relationships may exist. For example, A and/or B may represent the following three cases: Only A exists, both A and B exist, and only B exists. In addition, the term “at least one of” in this specification represents any one or any combination of at least two of the listed items. For example, “at least one of A, B, and C” may represent any one element or multiple elements selected from a set including A, B, and C.

In addition, for better illustration of the present disclosure, various specific details are given in the following specific implementation. A person skilled in the art should understand that the present disclosure may also be implemented without the specific details. In some instances, methods, means, elements, and circuits well known to a person skilled in the art are not described in detail, so as to highlight the subject matter of the present disclosure.

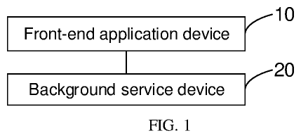

FIG. 1 is a block diagram of a teaching system according to an embodiment of the present disclosure. As shown in FIG. 1, the system comprises a background service device 20.

The background service device 20 is configured to: receive an experimental operation instruction sent by a front-end application device, wherein the experimental operation instruction is an operation instruction for performing a step of a target experiment in a curriculum package, the curriculum package includes one or more programming experiments, and the target experiment is any one of the one or more programming experiments;

execute the experimental operation instruction based on a running dependency package corresponding to the target experiment, to obtain an execution result; and

send the execution result to the front-end application device.

In this teaching system according to an embodiment of the present disclosure, the background service device can be used to receive the experimental operation instruction sent by the front-end application device, and execute the experimental operation instruction based on the running dependency package. The experimental operation instruction in the curriculum package can be designed to be easy for primary and secondary school students to learn, and is supported by the running dependency package. For example, an operation instruction is designed in the form of a building block and linked with a building block file. An experimental operation instruction corresponding to the building block file can be executed when the building block file runs after being clicked or dragged to a specific location. In this way, a programming operation is simplified, becomes more readable, and is easy for primary and secondary school students with poor basis to understand and digest.

The building block file is a file that is encapsulated in the form of a building block. The operation instruction of the building block file can be executed by performing building block operations such as clicking or dragging. In this way, the programming is easy to understand, and the logic is clear. The running dependency package includes a code package that supports the operation instruction of the building block file. An operation of the building block file may correspond to an operation instruction. The operation instruction may correspond to code in the running dependency package. By executing the code in the running dependency package, a computer can implement a function of the building block file.

In a possible implementation, the teaching system further includes a front-end application device 10.

The front-end application device 10 is configured to: receive an experimental operation instruction, and send the experimental operation instruction to a background service device, wherein the experimental operation instruction is an operation instruction for performing a step of a target experiment in a curriculum package, the curriculum package includes one or more programming experiments, and the target experiment is any one of the one or more programming experiments; and

receive and display an execution result corresponding to the experimental operation instruction.

The front-end application device and the backend service device are computer devices including a processor and a memory.

It is to be understood that the processor of the embodiment of the present disclosure may be an integrated circuit chip with signal processing capability. In the implementation process, each step of the above method embodiment can be completed by the instruction in the form of integrated logic circuit of hardware or software in the processor. The above processors can be general purpose processors, digital signal processors (DSPs), application specific integrated circuits (ASICs), field programmable gate arrays (FPGAs) or other programmable logic devices, discrete gate or transistor logic devices, and discrete hardware components. The disclosed methods, steps and logic block diagrams in the embodiments of the present disclosure can be implemented or executed. The general-purpose processor may be a microprocessor or the processor may be any conventional processor or the like. The steps of the method disclosed in connection with the embodiment of the present disclosure can be directly embodied in the execution completion of the hardware decoding processor, or by the combination of the hardware and software modules in the decoding processor. The software module can be located in random memory, flash memory, read-only memory, programmable read-only memory or electrically erasable programmable memory, register and other mature storage media in the art. The storage medium is located in the memory, and the processor reads the information in the memory and completes the steps of the above method in combination with its hardware.

It is to be understood that the memory in the embodiments of the present disclosure may be volatile memory or non-volatile memory, or may include both volatile and non-volatile memory. The nonvolatile memory can be read-only memory (ROM), programmable ROM (PROM), erasable Prom (EPROM), electrically erasable EPROM (EEPROM) or flash memory. Volatile memory can be random access memory (RAM), which is used as an external cache. Many forms of RAM are available, such as static RAM (SRAM), dynamic RAM (DRAM), synchronous DRAM (SDRAM), double data rate SDRAM (DDR SDRAM, enhanced SDRAM (ESDRAM), synchlink DRAM (SLDRAM) and direct Rambus RAM (DR RAM). It is to be noted that the memory of the systems and methods described herein is intended to include, but is not limited to, these and any other suitable types of memory.

It is to be understood that the above described memory is exemplary but not restrictive. For example, the memory in the embodiment of the present disclosure can also be static RAM (SRAM), dynamic RAM (DRAM), synchronous dynamic random access memory (synchronous DRAM (SDRAM), double data rate SDRAM (DDR SDRAM), enhanced SDRAM (ESDRAM), synchronous link DRAM (SLDRAM), direct RAM (DR RAM), etc. That is to say, the memory in the embodiments of the present disclosure is intended to include, but not limited to, these and any other suitable types of memory.

In this teaching system according to an embodiment of the present disclosure, the background service device can be used to receive the experimental operation instruction sent by the front-end application device, and execute the experimental operation instruction based on the running dependency package. The experimental operation instruction in the curriculum package can be designed to be easy for primary and secondary school students to learn, and is supported by the running dependency package. For example, an operation instruction is designed in the form of a building block and linked with a building block file. An experimental operation instruction corresponding to the building block file can be executed when the building block file runs after being clicked or dragged to a specific location. In this way, a programming operation is simplified, becomes more readable, and is easy for primary and secondary school students with poor basis to understand and digest.

In a possible implementation, the front-end application device and the background service device can be implemented in a BS architecture. The front-end application device can be implemented by using a browser on a general computer, or application software or a program installed on a computer, and the general computer does not need to be specially configured with a GPU for deep learning. The background service device can be implemented on a background server. One background service device may correspond to multiple front-end application devices, in other words, one background server may be connected to multiple front-end computers. Single-campus deployment or multi-campus deployment can be set according to different usage scenarios, and multiple front-end computers can be deployed in one campus.

In a possible implementation, the front-end application device can provide an operation interface for users by using a browser or an interface of application software or a program installed on a computer. In an example, the teaching system can be an artificial intelligence teaching system, and the curriculum package can be an artificial intelligence curriculum package. The front-end application device does not need to load a complex artificial intelligence software environment. When the artificial intelligence teaching system is used for artificial intelligence teaching, students can enter the experimental operation instruction through the operation interface of the front-end application device, and obtain an execution result, so as to learn artificial intelligence teaching content. For example, students can write code for identifying a target object in an image, to identify a preset pedestrian in the image. The front-end application device can send the written code to the background service device, and the background service device can execute the code based on the running dependency package, to obtain the execution result.

In a possible implementation, the curriculum package can be a curriculum package designed by a team of teachers. The curriculum package may include one or more courses or experiments. The courses or experiments can be designed by the team of teachers based on the learning pattern and comprehension ability of primary and secondary school students, and ordered in an easy-to-understand way. The curriculum package includes one or more programming experiments. The programming experiment can be an experiment corresponding to a course. For example, a teacher explains principles and experiment operations in the course, and students perform the programming experiment. The curriculum package includes teaching content and programming support content, wherein the teaching content includes the programming experiment, and the programming support content includes the running dependency package.

In a possible implementation, the front-end application device is further configured to display profile information of the curriculum package. The profile information may include course ID, course name, course description, internal version number, external version number, version description, author, course label, release time, course cover, and experiment list. In an example, the course description may include information such as the difficulty level of a course in the curriculum package and the grade of students the course is suitable for.

In a possible implementation, the front-end application device is further configured to display a user interface corresponding to profile information of the curriculum package, so as to receive the experimental operation instruction in the user interface. In an example, the front-end application device can display a corresponding user interface based on information in the course description such as the difficulty level and the grade of students the course is suitable for. For example, if the course or the experiment included in the curriculum package is relatively difficult and suitable for senior students, the corresponding user interface can be a standard programming interface, and the user interface can receive code (the experimental operation instruction) entered by students. If the course or the experiment included in the curriculum package is relatively simple and suitable for junior students, the corresponding user interface can be a more friendly interface, and experimental operation operations can be relatively simple. For example, students only need to concatenate functions in a logical order by “block building” without entering code. In other words, students can learn the roles and logical order of functions in a simple way. Each function can be displayed in the form of a “building block”. For example, the “building block” displayed may include an input port, an output port, or the like of a function, and students can concatenate the input ports and output ports of a plurality of “building blocks” in a logical order, so as to implement a specific function. Functions of these “building blocks” are supported by building block files, and the building block files may include code that supports the functions of the “building blocks” and the like. This embodiment of the present disclosure does not limit the display style and content of the user interface.

In a possible implementation, when students perform the target experiment, the entered experimental operation instruction can be easy-to-understand code or “building blocks”. The experimental operation instruction entered by students is only for the students to understand the principle and logic of artificial intelligence, and cannot be run directly. Therefore, the experimental operation instruction can be sent to the background service device. The experimental operation instruction can be supported and executed by the running dependency package corresponding to the target experiment in the background service device, so as to obtain the execution result. In an example, the running dependency package may include underlying code that supports the running of the experimental operation instruction. In an example, when the experimental operation instruction is sent to the background service device, the background service device can determine the running dependency package corresponding to the target experiment based on an API (Application Programming Interface) document of the experimental operation instruction, and execute the experimental operation instruction based on the running dependency package.

In this way, students can enter the experimental operation instruction in a simple manner, and obtain the execution result, so as to easily understand the principle and logic of an experiment, and improve learning efficiency.

In a possible implementation, the teaching system supports teaching staff and/or programmers to develop the curriculum package. To be specific, there is a development tool for the curriculum package or there is a link to a development platform for the curriculum package. The development platform for the curriculum package shares a background service device with the teaching system. When developing the curriculum package, developers can enter course information such as course profile information and experiment content by using the front-end application device, and send the course information to the background service device to create the curriculum package. In addition, developers can also enter the experimental operation instruction by using the front-end application device and perform a trial run of the developed experiment by using the background service device, thereby checking whether the developed experiment runs as expected. In this way, subsequent development can be performed or an instruction can be submitted, to generate a curriculum package that can be published on the teaching system for students to use in a programming experiment course.

In a possible implementation, the team of teachers only needs to organize the content and the order of the courses and the experiments in the curriculum package, and the underlying code in the running dependency package can be written by a professional technician or a person with programming skills in the team of teachers. The team of teachers can focus on the content and the order of the courses. The courses and the experiments can be arranged in an order from easy to difficult and from shallow to deep based on the learning pattern and comprehension ability of students, making it easy for students to learn and understand. The professional technician or the person with programming skills in the team of teachers can write the running dependency package to support the experimental operation instruction in the experiment.

In a possible implementation, the curriculum package may include one or more experiments. The curriculum package may also include profile information, description information, step information, and summary information of each experiment. The front-end application device is further configured to: upon receiving a selection operation on the target experiment in the curriculum package, display at least one of profile information, description information, step information, or summary information of the target experiment. In an example, the experiment profile information may include experiment name, experiment introduction, experiment difficulty level, experiment icon, experiment label, experiment user interface, running dependency package information, building block file, preprocessing instruction, and the like.

In a possible implementation, the front-end application device is further configured to import a preprocessing instruction corresponding to the target experiment. The preprocessing instruction can be a code package that supports the running of the experimental operation instruction. For example, if the experimental operation instruction is Python code, the preprocessing instruction can be a code package that supports a specific function in Python, for example, a pandas code package that supports a data processing function. The front-end application device can import the preprocessing instruction corresponding to the target experiment in advance before the target experiment is performed. This embodiment of the present disclosure does not limit the preprocessing instruction.

In this way, the front-end application device can import the preprocessing instruction corresponding to the target experiment. When performing the programming experiment, students do not need to write code to import the preprocessing instruction, making the experimental operation instruction simple and easy for students to understand.

In a possible implementation, after students enter the experimental operation instruction, the front-end application device can send the experimental operation instruction to the background service device, and the background service device can execute the experimental operation instruction based on the running dependency package corresponding to the target experiment, to obtain an execution result.

In a possible implementation, the curriculum package further includes curriculum content and interface document(s) (API document(s)) corresponding to the one or more programming experiments. The background service device is further configured to: upon receiving the experimental operation instruction, determine, based on the interface documents, the running dependency package corresponding to the target experiment from among the running dependency packages corresponding to the one or more programming experiments. In an example, the background service device may include running dependency packages respectively corresponding to the programming experiments. Upon receiving the experimental operation instruction, the background service device can determine the running dependency package corresponding to the target experiment based on the API document of the experimental operation instruction, and execute each experimental operation instruction in the target experiment based on the running dependency package. For example, the background service device can execute code corresponding to the experimental operation instruction in the running dependency package.

In this way, students can enter the experimental operation instruction in a simple manner, and obtain the execution result, so as to easily understand the principle and logic of an experiment, and improve learning efficiency.

In a possible implementation, the background service device includes a CPU (Central Processing Unit) resource and/or a GPU (Graphics Processing Unit) resource, and is configured to execute the corresponding code in the running dependency package. The executing the experimental operation instruction based on the running dependency package to obtain an execution result includes: determining, based on the running status of the CPU resource and/or the GPU resource, a target CPU and/or a target GPU configured to execute the experimental operation instruction; and executing a target instruction in the running dependency package by using the target CPU and/or the target GPU, to obtain the execution result, wherein the target instruction is an instruction in the running dependency package that is corresponding to the experimental operation instruction.

In this way, the computing capacity of the CPU resource and/or the GPU resource can be fully utilized, and utilization of the CPU resource and/or the GPU resource is improved, thereby providing support for more students.

In a possible implementation, before the experimental operation instruction is executed, the running status (runtime) of the CPU resource and/or the GPU resource can be determined, and the target CPU and/or the target GPU configured to execute the experimental operation instruction can also be determined. For example, one background service device may correspond to multiple front-end application devices. When a teacher explains an experiment operation, multiple students can send experimental operation instructions to the background service device using multiple front-end application devices. The background service device can dynamically determine the target CPU and/or the target GPU for the experimental operation instruction sent by each front-end application device based on the resource utilization of the target CPU and/or the target GPU. For example, at a certain moment, the utilization of all GPUs is between 50% to 80%, and there is one GPU with relatively low resource utilization of only 50%. In this case, the background service device delivers the next experimental operation instruction sent by the front-end application device to the GPU with relatively low resource utilization for processing. Alternatively, based on the set runtime in basic information of the experiment, the background service device can assign an experimental operation instruction that consumes more computing resources to run on the GPU, and assign an experimental operation instruction that consumes less computing resources to run on the CPU, and the like. This embodiment of the present disclosure does not limit the method for determining the target CPU and/or the target GPU.

In a possible implementation, the background service device can execute the target instruction corresponding to the experimental operation instruction in the running dependency package by using the target CPU and/or the target GPU. For example, the dependency package includes a function (building block file) corresponding to a “building block” and a call instruction. The target instruction in the running dependency package is determined based on the experimental operation instruction (for example, the function or the building block file corresponding to the “building block” as well as the call instruction are determined), and the function in the dependency package is called with the call instruction. The GPU can execute the target instruction to realize the function of the experimental operation instruction and obtain the execution result.

In this way, the computing capacity of the CPU resource and/or the GPU resource can be fully utilized, and utilization of the CPU resource and/or the GPU resource is improved, thereby providing support for more students.

In a possible implementation, after obtaining the execution result, the background service device can send the execution result to the front-end application device, and the front-end application device can receive and display the execution result.

In a possible implementation, the curriculum package includes teaching content and programming support content, wherein the teaching content includes the programming experiment, and the programming support content includes the running dependency package. The team of teachers can organize the content and the order of the courses and the experiments in the curriculum package. In other words, the team of teachers is responsible for editing the teaching content. The underlying code in the running dependency package can be written by a professional technician or a person with programming skills in the team of teachers. In other words, the professional technician or the person with programming skills is responsible for editing the programming support content. The front-end application device is further configured to send an editing instruction for editing the teaching content and/or the programming support content to the background service device. In an example, a user of the front-end application device can be a teacher, a professional technician, or a student. The teacher can edit the teaching content, and the professional technician can edit the programming support content. For example, the teacher or the professional technician can enter the editing instruction in the front-end application device, and the front-end application device can send the editing instruction to the background service device to edit the teaching content and/or the programming support content.

In this way, the curriculum package can be flexibly developed or modified, so as to improve flexibility of teaching and facilitate implementation of a teaching scheme.

In a possible implementation, the sending an editing instruction for editing the teaching content and/or the programming support content to the background service device includes: sending, to the background service device, a first editing instruction to edit the teaching content; and/or sending, to the background service device, a second editing instruction to edit the programming support content. For example, the teacher can enter the first editing instruction for editing the teaching content (for example, an instruction to edit a teaching target) in a first front-end application device, and the front-end application device can send the first editing instruction to the background service device, to edit the teaching content. The professional technician can enter the second editing instruction for editing the programming support content (for example, an instruction to edit the building block file) in a second front-end application device, and the front-end application device can send the second editing instruction to the background service device, to edit the programming support content.

In this way, the curriculum package can be edited by the front-end application device, making it easier to write or modify the curriculum package.

In a possible implementation, the background service device is further configured to receive an editing instruction for editing the teaching content and/or the programming support content; and edit the teaching content and the programming support content based on the editing instruction, to generate the curriculum package. In an example, the background service device can receive the editing instruction for editing the teaching content and/or the programming support content sent by the front-end application device. The receiving an editing instruction for editing the teaching content and/or the programming support content includes: receiving a first editing instruction from a first front-end application device to edit the teaching content; and/or receiving a second editing instruction from a second front-end application device to edit the programming support content. For example, the background service device can receive the first editing instruction entered by the teacher in the first front-end application device, and/or receive the second editing instruction entered by the professional technician in the second front-end application device. Further, the background service device can edit (for example, write or modify) the teaching content and/or the programming support content based on the first editing instruction or the second editing instruction. The editing of the teaching content and the programming support content based on the editing instruction to generate the curriculum package includes: editing the teaching content based on the first editing instruction to generate the curriculum package; and/or editing the programming support content based on the second editing instruction to generate the curriculum package. For example, the first editing instruction can be used to modify the content of the programming experiment in the teaching content, and the second editing instruction can be used to write the running dependency package of the programming experiment. After the editing is completed, the curriculum package can be written or updated.

In this way, the curriculum package can be edited by the front-end application device, making it easier to write or modify the curriculum package.

In a possible implementation, when editing the curriculum package, the teacher can invite the professional technician to write the curriculum package together, or the professional technician can invite the teacher to write the curriculum package together. For example, if the teacher intends to modify content of an experiment in the curriculum package, the teacher can invite the professional technician to write the curriculum package together, so as to modify both the experiment content and the running dependency package of the experiment. The front-end application device is further configured to send an invitation instruction to the background service device, so that the background service device invites another front-end application device to edit the curriculum package, wherein the invitation instruction includes an identifier of the another front-end application device. For example, the front-end application device used by the teacher can send an invitation instruction to the background service device, and the background service device can send the invitation instruction to the front-end application device used by the professional technician based on the identifier of the front-end application device. In this way, the teacher can invite the professional technician to edit the curriculum package together.

In an example, the background service device is further configured to: in response to an invitation instruction received from the first front-end application device, send an invitation request to the second front-end application device, to invite the second front-end application device to edit the curriculum package, wherein the invitation instruction includes an identifier of the second front-end application device; or in response to an invitation instruction received from the second front-end application device, send an invitation request to the first front-end application device, to invite the first front-end application device to edit the curriculum package, wherein the invitation instruction includes an identifier of the first front-end application device. For example, when receiving the invitation instruction sent by the first front-end application device used by the teacher, the background service device can send the invitation instruction to the second front-end application device based on the identifier of the second front-end application device (for example, an account ID for logging into the second front-end application device), to invite the professional technician who uses the second front-end application device to edit the curriculum package together. Alternatively, when receiving the invitation instruction sent by the second front-end application device used by the professional technician, the background service device can send the invitation instruction to the first front-end application device based on the identifier of the first front-end application device (for example, an IP address of the first front-end application device), to invite the teacher who uses the first front-end application device to edit the curriculum package together. Further, a user of a front-end application device can invite a plurality of users of other front-end application devices to edit the curriculum package together. For example, a teacher can invite a plurality of professional technicians to edit the curriculum package together, or a teacher can invite another teacher and one or more professional technicians to edit the curriculum package. This embodiment of the present disclosure does not limit users of the first front-end application device and the second front-end application device.

In this way, different users can edit the curriculum package together, so that the editing of the teaching content is synchronized with the editing of the programming support content.

In a possible implementation, the background service device is further configured to set a permission of the first front-end application device and a permission of the second front-end application device in a way that the permission of the first front-end application device is different from the permission of the second front-end application device. For example, the first front-end application device can be the front-end application device used by the teacher, the second front-end application device can be the front-end application device used by the professional technician, and the permission of the first front-end application device is different from the permission of the second front-end application device. For example, the first front-end application device can only be used to edit the teaching content, and the second front-end application device can only be used to edit the programming support content. For another example, the first front-end application device can be the front-end application device used by the student, the second front-end application device can be the front-end application device used by the teacher or the professional technician, and the permission of the first front-end application device is different from the permission of the second front-end application device. The first front-end application device can only be used to enter the experimental operation instruction instead of editing the curriculum package, and the second front-end application device can be used to enter the experimental operation instruction and edit the curriculum package (i.e., entering and editing instructions). This embodiment of the present disclosure does not limit the permission.

In this way, by setting the permission of the front-end application device, the front-end application device cannot randomly edit the curriculum package, thereby improving the content security of the curriculum package.

In this teaching system according to an embodiment of the present disclosure, students can enter the experimental operation instruction in a simple manner, and the background service device executes the experimental operation instruction based on the running dependency package, so as to enable students to easily understand the principle and logic of an experiment, and improve learning efficiency. The preprocessing instruction corresponding to the target experiment can be imported. When performing the programming experiment, students do not need to write code to import the preprocessing instruction, making the experimental operation instruction simple and easy for students to understand. Further, the computing capacity of the CPU resource and/or the GPU resource can be fully utilized, and utilization of the CPU resource and/or the GPU resource is improved, thereby providing support for more students. The experimental operation instruction in the curriculum package can be designed to be easy for primary and secondary school students to learn, and is supported by the running dependency package, making it easy for primary and secondary school students to understand and digest. The curriculum package can be edited in a flexible manner, and the editing of the teaching content and/or the programming support content can be synchronized in the curriculum package.

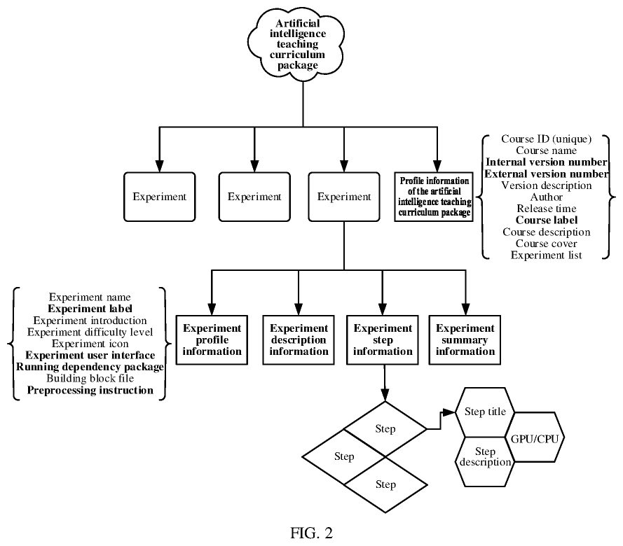

FIG. 2 is a schematic diagram of an application of a teaching system according to an embodiment of the present disclosure. As shown in FIG. 2, the curriculum package can be a curriculum package designed by a team of teachers. The curriculum package may include a plurality of experiments. These experiments can be designed by the team of teachers based on the learning pattern and comprehension ability of primary and secondary school students, and ordered in an easy-to-understand way.

In a possible implementation, profile information of the curriculum package can be displayed when the curriculum package is used for teaching. For example, the profile information may include one or more pieces of information such as course ID, course name, course description, internal version number, external version number, version description, author, course label, release time, course cover, and experiment list. The course description may include information such as the difficulty level of a course in the curriculum package and the grade of students the course is suitable for.

In a possible implementation, the front-end application device is configured to display a user interface corresponding to the profile information of the curriculum package. For example, if the experiment included in the curriculum package is relatively simple and suitable for junior students, the corresponding user interface can be a more friendly interface, and students only need to concatenate functions in a logical order by “block building” without entering code. In other words, students can learn the roles and logical order of functions in a simple way. Functions of these “building blocks” are supported by building block files, and the building block files may include code that supports the functions of the “building blocks” and the like. This embodiment of the present disclosure does not limit the display style and content of the user interface.

In a possible implementation, each experiment may include one or more pieces of information such as profile information, description information, step information, and summary information. When a target experiment is performed, the experiment profile information can be displayed, including experiment name, experiment introduction, experiment difficulty level, experiment icon, experiment label, experiment user interface, running dependency package information, building block file, and preprocessing instruction.

In a possible implementation, the user interface of the front-end application device can receive an experimental operation instruction of “block building”, and send the experimental operation instruction to the background service device, and the background service device can determine the running dependency package corresponding to the target experiment based on the API document of the experimental operation instruction. The running dependency package can be written by a professional technician or a person with programming skills in the team of teachers.

In a possible implementation, before the experimental operation instruction is executed, the running status of the CPU resource and/or the GPU resource can be determined, the target CPU and/or the target GPU configured to execute the experimental operation instruction can be determined, and the target instruction in the running dependency package can be executed by the target CPU and/or the target GPU. For example, the target instruction can be used to call a building block file based on the logical order of the experimental operation instruction to realize the function of the experimental operation instruction, obtain the execution result, and send the execution result to the front-end application device.

In a possible implementation, the course and experimental content of the artificial intelligence teaching system can be designed by the team of teachers, and can be supported by the professional technician who can write the running dependency package. The team of teachers and the professional technician can cooperate with each other to make the course more reasonable. The course and the experiment can be designed based on the learning pattern to make the artificial intelligence course easy for primary and secondary school students to understood, thereby popularizing artificial intelligence education.

For example, the experiment content, such as course basic information, experiment description, experiment summary, experiment operations, and some experiment basic information, can be carefully designed by a front-line teacher or a teaching and research team based on the physical and psychological characteristics, learning pattern and comprehension ability of primary and secondary school students. The teaching and research team can design a series of experiments, and show students the knowledge points to be mastered in an order from easy to difficult and from shallow to deep.

Underlying support and implementation of experimental code that students need to complete can be synchronously developed by a professional programmer. In addition to a part written by students, the experimental code further includes a student code API document, a running dependency package, and experimental runtime information (including a background execution engine, a front-end experiment UI type, and a building block file). In an experiment package, the experiment UI version, the dependency package, the building block file, the preprocessing code, and the execution engine for each operation are completed by the programming developer. All other parts fall in the scope of experiment content, and are designed by the professional teacher, the teaching and research team, or a third-party development team.

It is to be understood that the system embodiments described above in the present disclosure can be combined with each other to form a combined embodiment as long as principles and logic are not violated. For brevity, details are not described herein.

In addition, the present disclosure further provides a teaching method, an electronic device, a computer-readable storage medium, and a computer program, which can be used to implement any image processing method provided in the present disclosure. Related technical solutions and information are described in the method embodiment. Details are not described herein.

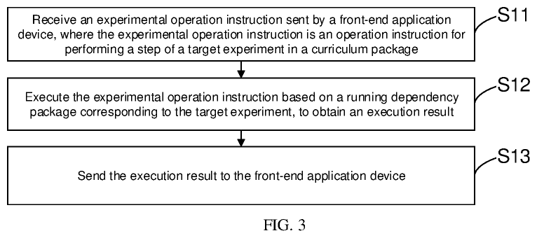

FIG. 3 is a flowchart of a teaching method according to an embodiment of the present disclosure. Operations of the teaching method can be performed by hardware, for example a terminal, or performed by a processor by running computer executable code. The method can be applied to a background service device, including:

Operation 11: Receiving an experimental operation instruction sent by a front-end application device, wherein the experimental operation instruction is an operation instruction for performing a step of a target experiment in a curriculum package, the curriculum package includes one or more programming experiments, and the target experiment is any one of the one or more programming experiments.

Operation 12: Executing the experimental operation instruction based on a running dependency package corresponding to the target experiment, to obtain an execution result.

Operation 13: Sending the execution result to the front-end application device.

In a possible implementation, the curriculum package further includes curriculum content and interface document(s) corresponding to the one or more programming experiments; and

the method further includes:

upon receiving the experimental operation instruction, determining, based on the interface documents, the running dependency package corresponding to the target experiment from among the running dependency packages corresponding to the one or more programming experiments.

In a possible implementation, the background service device includes a CPU resource and/or a GPU resource; and

the executing the experimental operation instruction based on the running dependency package to obtain an execution result includes:

determining, based on the running status of the CPU resource and/or the GPU resource, a target CPU and/or a target GPU configured to execute the experimental operation instruction; and

executing a target instruction in the running dependency package by using the target CPU and/or the target GPU, to obtain the execution result, wherein the target instruction is an instruction in the running dependency package that is corresponding to the experimental operation instruction.

In a possible implementation, the curriculum package includes teaching content and programming support content, wherein the teaching content includes the programming experiment, and the programming support content includes the running dependency package; and

the method further includes:

receiving an editing instruction for editing the teaching content and/or the programming support content; and

editing the teaching content and the programming support content based on the editing instruction, to generate the curriculum package.

In a possible implementation, receiving an editing instruction for editing the teaching content and/or the programming support content includes:

receiving a first editing instruction from a first front-end application device to edit the teaching content; and/or receiving a second editing instruction from a second front-end application device to edit the programming support content; and

editing the teaching content based on the first editing instruction to generate the curriculum package; and/or editing the programming support content based on the second editing instruction to generate the curriculum package.

In a possible implementation, the method further includes:

in response to an invitation instruction received from the first front-end application device, sending an invitation request to the second front-end application device, to invite the second front-end application device to edit the curriculum package, wherein the invitation instruction includes an identifier of the second front-end application device; or

in response to an invitation instruction received from the second front-end application device, sending an invitation request to the first front-end application device, to invite the first front-end application device to edit the curriculum package, wherein the invitation instruction includes an identifier of the first front-end application device.

In a possible implementation, the method further includes:

setting a permission of the first front-end application device and a permission of the second front-end application device in a way that the permission of the first front-end application device is different from the permission of the second front-end application device.

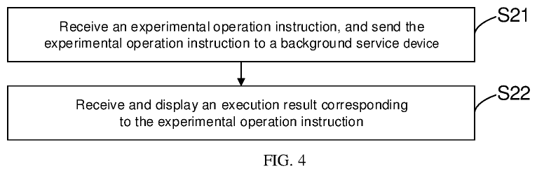

FIG. 4 is a flowchart of a teaching method according to an embodiment of the present disclosure. Operations of the teaching method can be performed by hardware, for example a terminal, or performed by a processor by running computer executable code. The method can be applied to a front-end application device, including:

Operation 21: Receiving an experimental operation instruction, and sending the experimental operation instruction to a background service device, wherein the experimental operation instruction is an operation instruction for performing a step of a target experiment in a curriculum package, the curriculum package includes one or more programming experiments, and the target experiment is any one of the one or more programming experiments.

Operation 22: Receiving and displaying an execution result corresponding to the experimental operation instruction.

In a possible implementation, the method further includes:

displaying profile information of the curriculum package.

In a possible implementation, the method further includes:

upon receiving a selection operation on the target experiment in the curriculum package, displaying at least one of profile information, description information, step information, or summary information of the target experiment.

In a possible implementation, the method further includes:

importing a preprocessing instruction corresponding to the target experiment.

In a possible implementation, the method further includes:

displaying a user interface corresponding to profile information of the curriculum package, so as to receive the experimental operation instruction in the user interface.

In a possible implementation, the curriculum package includes teaching content and programming support content, wherein the teaching content includes the programming experiment, and the programming support content includes a running dependency package of the programming experiment; and

the method further includes:

sending an editing instruction for editing the teaching content and/or the programming support content to the background service device.

In a possible implementation, sending an editing instruction for editing the teaching content and/or the programming support content to the background service device includes:

sending, to the background service device, a first editing instruction to edit the teaching content; and/or

sending, to the background service device, a second editing instruction to edit the programming support content.

In a possible implementation, the method further includes:

sending an invitation instruction to the background service device, so that the background service device invites another front-end application device to edit the curriculum package, wherein the invitation instruction includes an identifier of the another front-end application device.

For an execution process of each operation of the teaching method embodiment, reference may be made to a function implementation process of the teaching system embodiment in the embodiments of the present disclosure. Details are not repeated herein. A person skilled in the art should understand that in the method in the specific embodiment, the listed order of the operations may not necessarily be the execution order and does not limit the implementation process. The specific execution order of the operations should be determined according to functions and internal logic of the operations.

An embodiment of the present disclosure further provides a computer-readable storage medium. The computer-readable storage medium stores a computer program instruction, and the method is implemented when a processor executes the computer program instruction. The computer-readable storage medium can be a volatile computer-readable storage medium or a non-volatile computer-readable storage medium.

An embodiment of the present disclosure further provides a computer program product. The computer program product includes a computer program instruction, and the method is implemented when a processor executes the computer program instruction.

An embodiment of the present disclosure further provides an electronic device, including: a processor, and a memory configured to store an instruction executable by the processor, wherein the processor is configured to perform the method.

The electronic device can be provided as a terminal, a server, or a device of another form.

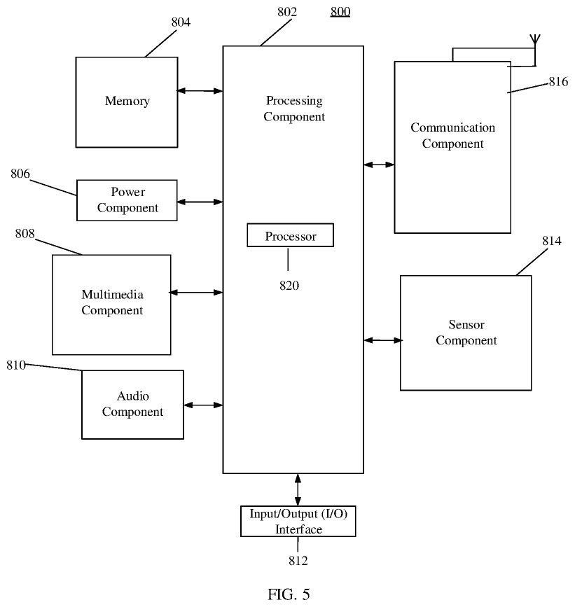

FIG. 5 is a block diagram of an electronic device 800 according to an exemplary embodiment. For example, the electronic device 800 can be a terminal such as a mobile phone, a computer, a digital broadcasting terminal, a message transceiver device, a game console, a tablet device, a medical device, a fitness device, and a personal digital assistant.

Referring to FIG. 5, the electronic device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute an instruction, to complete all of or some of the operations of the method. In addition, the processing component 802 may include one or more modules, to facilitate interaction between the processing component 802 and another component. For example, the processing component 802 may include a multimedia module, so as to facilitate interaction between the multimedia component 808 and the processing component 802.

The memory 804 is configured to store various types of data to support an operation performed on the electronic device 800. Examples of the data include instructions for any application or method operated on the electronic device 800, contact data, phone book data, messages, pictures or videos. The memory 804 can be implemented using any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 supplies power to various components of the electronic device 800. The power component 806 may include a power management system, one or more power supplies, and other components associated with power generation, management, and distribution in the electronic device 800.

The multimedia component 808 includes a screen providing an output interface between the electronic device 800 and the user. In some embodiments, the screen may include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensor can not only sense a boundary of a touch action or a swipe action, but also detect duration and pressure associated with the touch action or the swipe action. In some embodiments, the multimedia component 808 includes a front-facing camera and/or a rear-facing camera. The front-facing camera and/or the rear-facing camera can receive external multimedia data when the electronic device 800 is in an operation mode, such as a photo mode or a video mode. Each of the front-facing camera and the rear-facing camera can be a fixed optical lens system or have focal length and optical zoom capability.

The audio component 810 is configured to output and/or input an audio signal. For example, the audio component 810 includes a microphone (MIC) configured to receive an external audio signal when the electronic device 800 is in an operation mode, such as a call mode, a recording mode, and a voice recognition mode. The received audio signal can be further stored in the memory 804 or transmitted via the communication component 816. In some embodiments, the audio component 810 further includes a speaker to output an audio signal.

The I/O interface 812 provides an interface between the processing component 802 and a peripheral interface module, and the peripheral interface module can be a keyboard, a click wheel, buttons, and the like. The buttons may include, but are not limited to, a home button, a volume button, a start button, and a lock button.

The sensor component 814 includes one or more sensors to provide status assessments of various aspects of the electronic device 800. For example, the sensor component 814 can detect an on/off status of the electronic device 800 and a relative positioning of a component, such as a monitor or a keypad of the electronic device 800. The sensor component 814 can further detect a change in position of the electronic device 800 or a component of the electronic device 800, whether the user is in contact with the electronic device 800 or not, an orientation or an acceleration/deceleration of the electronic device 800, and a change in temperature of the electronic device 800. The sensor component 814 can include a proximity sensor, configured to detect the presence of a nearby object without any physical contact. The sensor component 814 can further include a light sensor, such as a CMOS or CCD image sensor, for use in imaging applications. In some embodiments, the sensor component 814 can further include an acceleration sensor, a gyroscope sensor, a magnetic sensor, a pressure sensor, or a temperature sensor.

The communication component 816 is configured to facilitate wired or wireless communication between the electronic device 800 and another device. The electronic device 800 can access a wireless network based on a communication standard, such as WiFi, 2G, or 3G, or a combination thereof. In one exemplary embodiment, the communication component 816 receives a broadcast signal or broadcast-related information from an external broadcast management system via a broadcast channel In one exemplary embodiment, the communication component 816 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 800 can be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the method.

In exemplary embodiments, a non-volatile computer-readable storage medium is further provided, such as the memory 804 storing a computer program instruction, and the computer program instruction can be executed by the processor 820 of the electronic device 800 to complete the method.

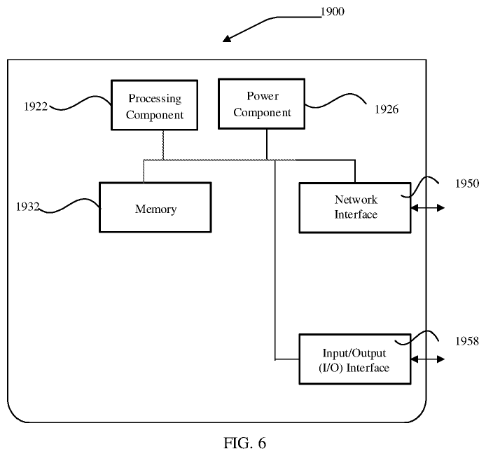

FIG. 6 is a block diagram of an electronic device 1900 according to an exemplary embodiment. For example, the electronic device 1900 can be provided as a server. Referring to FIG. 6, the electronic device 1900 includes a processing component 1922, which further includes one or more processors, and storage resources represented by a memory 1932 for storing an instruction executable by the processing component 1922, for example, an application. The application stored in the memory 1932 may include one or more modules each corresponding to a set of instructions. Further, the processing component 1922 is configured to execute instructions to perform the method.

The electronic device 1900 may further include a power component 1926 configured to perform power management for the electronic device 1900, a wired or wireless network interface 1950 configured to connect the electronic device 1900 to a network, and an input/output (I/O) interface 1958. The electronic device 1900 can operate based on an operating system stored in the memory 1932, such as Windows Server™, MAC OS X™ Unix™, Linux™, or FreeBSD™.

In exemplary embodiments, a non-volatile computer-readable storage medium is further provided, such as the memory 1932 storing a computer program instruction, and the computer program instruction can be executed by the processing component 1922 of the electronic device 1900 to complete the method.

The embodiments of the present disclosure can be provided as a system, a method, and/or a computer program product. The computer program product may include a computer-readable storage medium having computer-readable program instructions thereon to enable the processor to implement various aspects of the embodiments of the present disclosure.

The computer-readable storage medium can be a tangible device that can retain and store instructions for use by an instruction execution device. The computer-readable storage medium can be, for example, but is not limited to, an electrical storage device, a magnetic storage device, an optical storage device, an electromagnetic storage device, a semiconductor storage device, or any suitable combination thereof. A non-exhaustive list of more specific examples of the computer-readable storage medium includes: a portable computer disk, a hard disk, a random access memory (RAM), a read-only memory (ROM), an erasable programmable read-only memory (EPROM or a flash memory), a static random access memory (SRAM), a portable compact disc read-only memory (CD-ROM), a digital versatile disc (DVD), a memory stick, a floppy disk, a mechanical coding device such as a punched card or a raised structure in a groove having instructions stored thereon, and any suitable combination thereof. The computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable program instruction described herein can be downloaded to respective computing/processing devices from the computer-readable storage medium or to an external computer or external storage device via a network such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or network interface in each computing/processing device receives the computer-readable program instruction from the network and forwards the computer-readable program instruction for storage in the computer-readable storage medium within the respective computing/processing device.

The computer program instruction used to perform the operation of the embodiments of the present disclosure can be an assembly instruction, an instruction set architecture (ISA) instruction, a machine instruction, a machine-related instruction, microcode, a firmware instruction, status setting data, or source code or object code written in any combination of one or more programming languages. The programming languages include object-oriented programming languages such as Smalltalk and C++, and conventional procedural programming languages such as “C” language or similar programming language. The computer-readable program instruction can execute entirely on a user computer, partly on a user computer, as a stand-alone software package, partly on a user computer and partly on a remote computer, or entirely on a remote computer or server. In the latter scenario, the remote computer can be connected to the user computer via any type of network, including a local area network (LAN) or a wide area network (WAN), or the connection can be made to an external computer (for example, via the Internet using an Internet Service Provider). In some embodiments, an electronic circuit such as a programmable logic circuit, a field programmable gate array (FPGA) or a programmable logic array (PLA) can be customized by using status information of the computer-readable program instruction. The electronic circuit can execute the computer-readable program instruction to implement various aspects of the embodiments of the present disclosure.

Various aspects of the embodiments of the present disclosure are described herein with reference to the flowcharts and/or block diagrams of the method, the device (system), and the computer program product according to the embodiments of the present disclosure. It is to be understood that each block in the flowcharts and/or the block diagrams and a combination of blocks in the flowcharts and/or the block diagrams can be implemented by the computer-readable program instruction.

These computer-readable program instructions can be provided for a general-purpose computer, a dedicated computer, or a processor of other programmable data processing devices to generate a machine, so that when the instructions are executed by the computer or the processor of any other programmable data processing devices, an device for implementing the specific functions/actions in one or more blocks in the flowcharts and/or block diagrams is generated. These computer-readable program instructions can alternatively be stored in the computer-readable storage medium. These instructions direct the computer, the programmable data processing device, and/or other devices to work in a specific manner. Therefore, the computer-readable medium that stores the instructions includes an artifact, and the artifact includes instructions to implement various aspects of the functions/actions specified in one or more blocks in the flowcharts and/or block diagrams.

These computer-readable program instructions can alternatively be loaded onto a computer, another programmable data processing device, or other devices, so that a series of operation operations are performed on the computer, the another programmable data processing device, or the other devices, thereby generating a computer-implemented process. Therefore, the instructions executed on the computer, the another programmable data processing device, or the other devices can implement the specific functions/actions in one or more blocks in the flowcharts and/or block diagrams.

The flowcharts and block diagrams in the accompanying drawings show architectures, functions, and operations of possible implementations of the system, the method, and the computer program product according to multiple embodiments of the present disclosure. In this regard, each block in the flowcharts or block diagrams may represent a module, a program segment, or a part of an instruction, and the module, the program segment, or the part of the instruction includes one or more executable instructions for implementing specified logical functions. In some alternative implementations, the functions marked in the blocks can also be performed in an order different from that marked in the accompanying drawings. For example, two consecutive blocks can actually be executed in parallel, and they can sometimes be executed in reverse order, depending on the functions involved. It should also be noted that each block in the block diagrams and/or flowcharts and a combination of blocks in the block diagrams and/or flowcharts can be implemented by a dedicated hardware-based system that performs specified functions or actions, or can be implemented by a combination of dedicated hardware and computer instructions.

The embodiments of the present disclosure have been described above, but the description is illustrative and not exhaustive. The present disclosure is not limited to the disclosed embodiments. Many modifications and variations will be apparent to those of ordinary skill in the art without departing from the scope and spirit of the embodiments. The choice of terms used herein is intended to best explain the principles, practical applications, or technical improvements of the technology in the market in the embodiments, or to enable those of ordinary skill in the art to understand the embodiments disclosed herein.

1. A teaching method, applied to a background service device, comprising:
receiving an experimental operation instruction sent by a front-end application device, wherein the experimental operation instruction is an operation instruction for performing a step of a target experiment in a curriculum package, the curriculum package comprises one or more programming experiments, and the target experiment is any one of the one or more programming experiments;
executing the experimental operation instruction based on a running dependency package corresponding to the target experiment, to obtain an execution result; and
sending the execution result to the front-end application device.

2. The method according to claim 1, wherein the curriculum package further comprises curriculum content and interface document(s) corresponding to the one or more programming experiments; and
the method further comprises:
upon receiving the experimental operation instruction, determining, based on the interface documents, the running dependency package corresponding to the target experiment from among the running dependency packages corresponding to the one or more programming experiments.

3. The method according to claim 1, wherein the background service device comprises a CPU resource and/or a GPU resource; and
the executing the experimental operation instruction based on the running dependency package to obtain an execution result includes:
determining, based on the running status of the CPU resource and/or the GPU resource, a target CPU and/or a target GPU configured to execute the experimental operation instruction; and
executing a target instruction in the running dependency package by using the target CPU and/or the target GPU, to obtain the execution result, wherein the target instruction is an instruction in the running dependency package that is corresponding to the experimental operation instruction.

4. The method according to claim 1, wherein the curriculum package comprises teaching content and programming support content, the teaching content comprises the programming experiment, and the programming support content comprises the running dependency package; and
the method further comprises:
receiving an editing instruction for editing the teaching content and/or the programming support content; and
editing the teaching content and the programming support content based on the editing instruction, to generate the curriculum package.

5. The method according to claim 4, wherein the receiving an editing instruction for editing the teaching content and/or the programming support content comprises:
receiving a first editing instruction from a first front-end application device to edit the teaching content; and/or receiving a second editing instruction from a second front-end application device to edit the programming support content; and
editing the teaching content based on the first editing instruction to generate the curriculum package; and/or editing the programming support content based on the second editing instruction to generate the curriculum package.

6. The method according to claim 5, further comprising:
in response to an invitation instruction received from the first front-end application device, sending an invitation request to the second front-end application device, to invite the second front-end application device to edit the curriculum package, wherein the invitation instruction comprises an identifier of the second front-end application device; or
in response to an invitation instruction received from the second front-end application device, sending an invitation request to the first front-end application device, to invite the first front-end application device to edit the curriculum package, wherein the invitation instruction comprises an identifier of the first front-end application device.

7. The method according to claim 5, further comprising:
setting a permission of the first front-end application device and a permission of the second front-end application device in a way that the permission of the first front-end application device is different from the permission of the second front-end application device.

8. A teaching method, applied to a front-end application device, comprising:
receiving an experimental operation instruction, and sending the experimental operation instruction to a background service device, wherein the experimental operation instruction is an operation instruction for performing a step of a target experiment in a curriculum package, the curriculum package comprises one or more programming experiments, and the target experiment is any one of the one or more programming experiments; and
receiving and displaying an execution result corresponding to the experimental operation instruction.

9. The method according to claim 8, further comprising:
upon receiving a selection operation on the target experiment in the curriculum package, displaying at least one of profile information, description information, step information, or summary information of the target experiment.

10. The method according to claim 8, wherein the curriculum package comprises teaching content and programming support content, the teaching content comprises the programming experiment, and the programming support content comprises a running dependency package of the programming experiment; and
the method further comprises:
sending an editing instruction for editing the teaching content and/or the programming support content to the background service device.

11. The method according to claim 10, wherein the sending an editing instruction for editing the teaching content and/or the programming support content to the background service device comprises:
sending, to the background service device, a first editing instruction to edit the teaching content; and/or
sending, to the background service device, a second editing instruction to edit the programming support content.

12. The method according to claim 10, further comprising:
sending an invitation instruction to the background service device, so that the background service device invites another front-end application device to edit the curriculum package, wherein the invitation instruction comprises an identifier of the another front-end application device.

13. A teaching system, comprising a background service device, wherein
the background service device is configured to: receive an experimental operation instruction sent by a front-end application device, wherein the experimental operation instruction is an operation instruction for performing a step of a target experiment in a curriculum package, the curriculum package comprises one or more programming experiments, and the target experiment is any one of the one or more programming experiments;
execute the experimental operation instruction based on a running dependency package corresponding to the target experiment, to obtain an execution result; and
send the execution result to the front-end application device.

14. The system according to claim 13, wherein the curriculum package further comprises curriculum content and one or more interface documents corresponding to the one or more programming experiments; and
the background service device is further configured to: upon receiving the experimental operation instruction, determine, based on the interface documents, the running dependency package corresponding to the target experiment from among the running dependency packages corresponding to the one or more programming experiments.

15. The system according to claim 13, wherein the background service device comprises a CPU resource and/or a GPU resource; and
the background service device is further configured to: determine, based on a running status of the CPU resource and/or the GPU resource, a target CPU and/or a target GPU configured to execute the experimental operation instruction; and
execute a target instruction in the running dependency package by using the target CPU and/or the target GPU, to obtain the execution result, wherein the target instruction is an instruction in the running dependency package that is corresponding to the experimental operation instruction.

16. The system according to claim 13, wherein the curriculum package comprises teaching content and programming support content, the teaching content comprises the programming experiment, and the programming support content comprises the running dependency package; and
the background service device is further configured to: receive an editing instruction for editing the teaching content and/or the programming support content; and
edit the teaching content and the programming support content based on the editing instruction, to generate the curriculum package.

17. The system according to claim 13, wherein the background service device is further configured to: receive a first editing instruction from a first front-end application device to edit the teaching content; and/or receive a second editing instruction from a second front-end application device to edit the programming support content; and
edit the teaching content based on the first editing instruction to generate the curriculum package; and/or edit the programming support content based on the second editing instruction to generate the curriculum package.

18. A teaching system, comprising:
a processor, and
a memory configured to store an instruction executable by the processor,
wherein the processor is configured to call the instruction stored in the memory to perform the method according to claim 8.

19. A non-transitory computer readable storage medium having stored thereon computer program instructions that, when executed by a computer, cause the computer to perform the method of claim 1.

20. A non-transitory computer readable storage medium having stored thereon computer program instructions that, when executed by a computer, cause the computer to perform the method of claim 8.
